(19) United States
(12) Patent Application Publication
(10) Pub. No.: US 2013/0169211 A1
(43) Pub. Date: Jul. 4, 2013

(54) METHOD FOR CHARGING AN ELECTRIC BATTERY

(71) Applicants: David Brun-Buisson, Vatilieu (FR); Arnaud Delaille, Bassens (FR); Jean-Marie Klein, Communay (FR)

(72) Inventors: David Brun-Buisson, Vatilieu (FR); Arnaud Delaille, Bassens (FR); Jean-Marie Klein, Communay (FR)

(21) Appl. No.: 13/819,638

(22) PCT Filed: Aug. 29, 2011
(86) PCT No.: PCT/EP2011/064803

§ 371 Date: Mar. 21, 2013

(30) Foreign Application Priority Data
Aug. 30, 2010 (FR) 1056856

(51) Int. Cl. H02J 7/00

(52) U.S. Cl. CPC H02J 7/007
USPC 320/101; 320/162; 320/107

(57) ABSTRACT

Method for charging an electric battery with a given charge capacity, the electric battery feeding a charge and the electric battery being charged by an electrical energy source, wherein the method defining a first level of charge reference value lower than the charge capacity of the battery and a step of charging the electric battery until the first level of charge reference value is reached.

The present invention relates to a method for charging an electric battery, the electric battery feeding a charge and the electric battery being charged by an electrical energy source. The invention also relates to a data medium comprising means for carrying out such a method. The invention also relates to a charging device comprising means to carry out the charging method. The invention finally relates to a system comprising a charging device of this type and a software program to carry out the charging method.

In electrical systems, it is known for an electric battery to be used to store the electrical energy allowing an electrical charge to be fed. The battery stores the energy to provide a service and continuous operation of the charge. A plurality of battery technologies are known. An electrochemical accumulator is normally mainly used as the battery, for example of the lead or Li-Ion or Ni-MH type. A plurality of parameters must be taken into consideration in choosing the battery. First of all, the technology most suited to the energy and power requirements must be determined. Considering the current problems of dwindling fossil fuel resources and therefore future difficulties in producing energy, the reduction of the energy lost during the life cycle of the battery also becomes a significant aspect. In this context, it is important to improve the energy efficiency of the systems. There is therefore a need to develop electronic management circuits to optimise energy storage performance. These circuits must increase energy conversion efficiency, provide safety for the user, but must also protect the battery in order to avoid irreversible damage.

In the design of an electrical system, the battery is dimensioned through worst-case modelling. For example, a stand-alone system with a photovoltaic energy source is dimensioned to operate during the winter period (weak solar radiation). In summer, this system has an excess of energy. This results in low-amplitude charge cycles at a high level of charge of the battery in summer.

It appears that a high level of charge of the battery and low-amplitude charge cycles are likely to damage the battery. These phenomena cause damage to the material enabling the storage and therefore a deterioration in the energy storage and recovery properties. This phenomenon is further amplified at high temperatures.

In systems known in the prior art, the charging logic of the batteries consists in charging the batteries when an electrical energy source is available for this purpose. For example, the battery of an electric motor vehicle connected to an electrical source is charged immediately to its maximum level of charge. Similarly, a stand-alone photovoltaic system charges a battery when the photovoltaic panel produces electricity and the battery is not fully charged. This logic causes damage to the batteries in the long term.

This damage problem is illustrated by the experiment which follows. Four batteries are considered, of identical constitution, each charged at 0%, at 50%, at 75% and at 100% of their charge capacity. These batteries are stored for 60 days at 25° C. without being subjected to charging or discharging cycles. At the end of this storage, the maximum capacity of each of the four batteries is determined. It was noted that, during the storage period, the different batteries underwent the following irreversible capacity loss percentages:
0.09% per day of storage for the battery charged at 100%;
0.06% per day of storage for the battery charged at 75%;
0.04% per day of storage for the battery charged at 50%; and
virtually no loss for the battery charged at 0%.

The object of the invention is to provide a charging method which overcomes the aforementioned problems and improves the charging methods known in the prior art. In particular, the invention proposes a method for charging an electric battery which limits the wear of the latter. Furthermore, the invention proposes a charging device to achieve this object.

The method according to the invention enables the charging of an electric battery with a given charge capacity, the electric battery feeding a charge and the electric battery being charged by an electrical energy source. The method comprises a step of definition of a first charge reference value lower than the charge capacity of the battery and a step of charging the electric battery until the first charge reference value is reached.

The first charge reference value may depend on a first set of parameters.

The first set of parameters may comprise a parameter to predict the energy which should be delivered by the battery to feed the charge in a first given time range and/or a parameter to predict the energy which could be received from the electrical energy source by the battery in a second given time range and/or a level of stand-alone use of the electrical charge and/or a level of charge of the battery below which it is not desirable to fall.

The method may comprise a step of definition of a second charge reference value and a step of charging the electric battery until the first or the second charge reference value is reached.

The second charge reference value may depend on a second set of parameters.

The second set of parameters may comprise a parameter to predict the energy which will have to be delivered by the battery to feed the charge in a third given time range and/or a parameter to predict the energy which will be able to be received from the electrical energy source by the battery in a fourth given time range and/or a battery preservation level and/or a level of stand-alone use of the electrical charge and/or a level of charge of the battery below which it is not desirable to fall.

The second charge reference value may be equal to the charge capacity of the battery.

According to the invention, a data recording medium readable by a computer on which a computer program is recorded comprises software means to carry out the steps of the previously defined method.

According to the invention, the device for charging an electric battery comprises hardware and/or software means to carry out the previously defined charging method.

The hardware and/or software means may comprise a logical processing unit and/or a means for activating and deactivating the charging of the battery.

According to the invention, the power supply system comprises a previously defined charging device and an electric battery.

The power supply system may comprise an electrical energy source, notably a photovoltaic panel.

According to the invention, the system comprises a previously defined power supply system and an electrical charge.

According to the invention, the computer program comprises a computer program code means suitable for carrying out the previously defined steps of the method, when the program runs on a computer.

The term “charge reference” is understood notably to mean “level of charge reference” or “state of charge reference”.

The attached drawings show, by way of example, an embodiment of a charging method according to the invention and an embodiment of a charging device according to the invention.

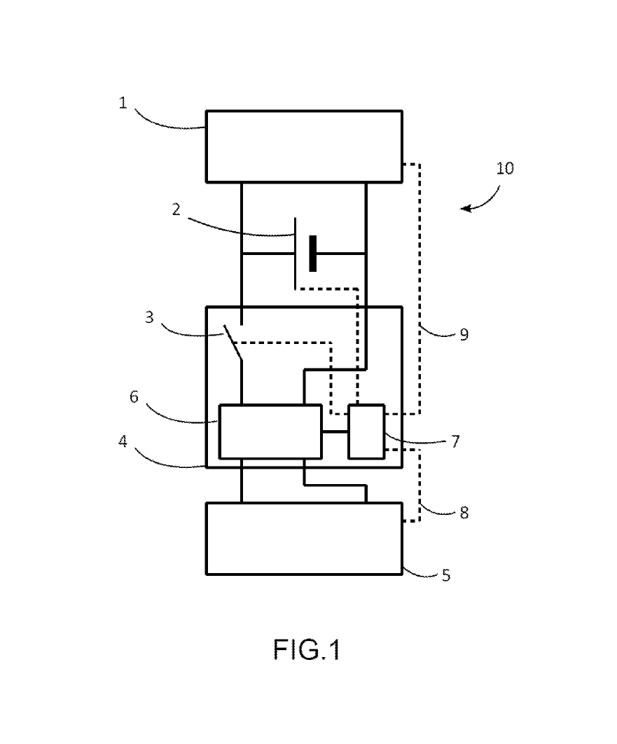

FIG. 1 is a diagram of an embodiment of the charging device according to the invention.

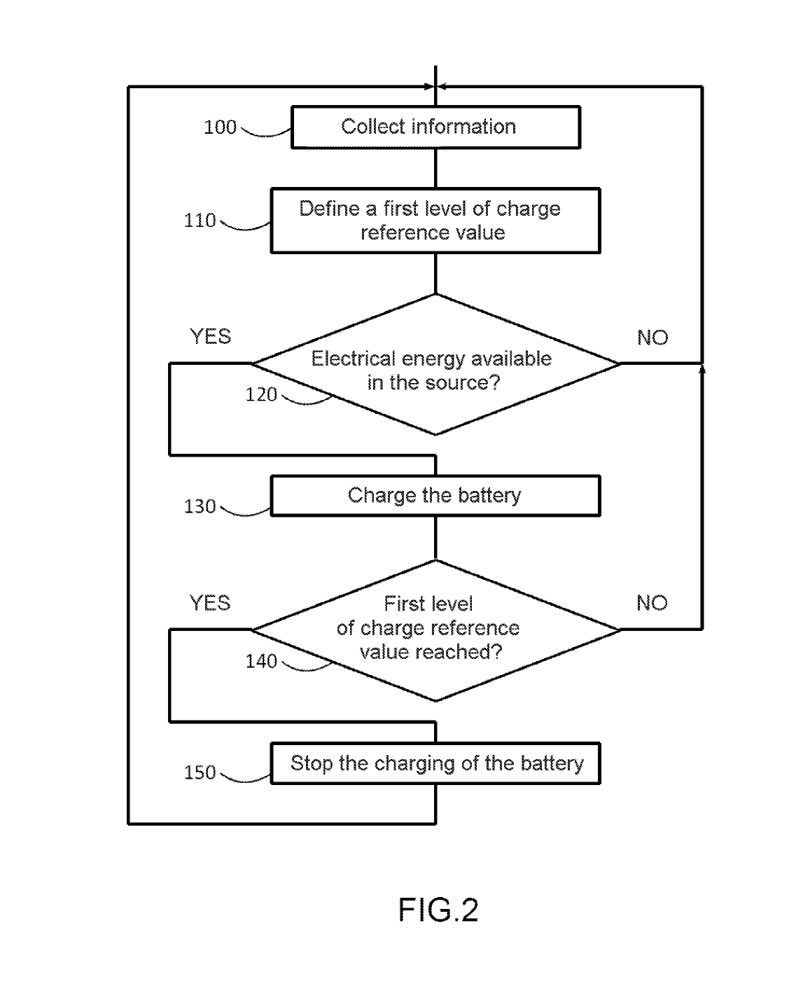

FIG. 2 is a flowchart of an embodiment of a charging method according to the invention.

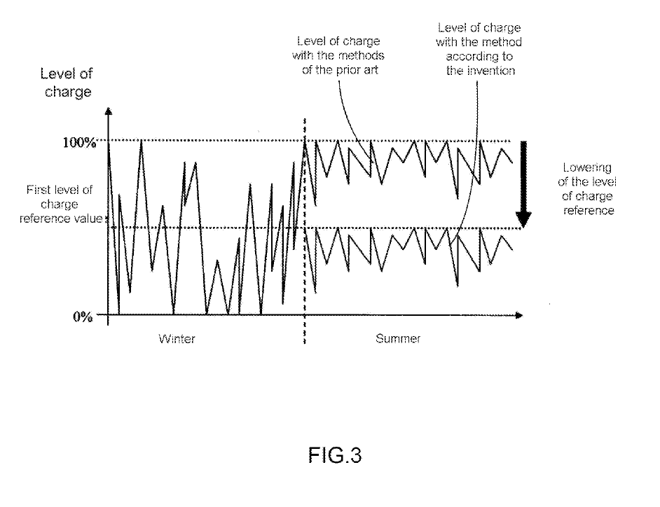

FIG. 3 is a graph showing the increase in the average level of charge of the battery thanks to the invention in an example of an electrical system.

An embodiment of an electrical system 10 according to the invention is described below in detail with reference to FIG. 1. The electrical system mainly comprises an electrical charge 1, an electric battery 2, a device 4 for charging the electric battery and an electrical energy source 5.

The electric battery feeds the electrical charge. Furthermore, the electrical energy source charges the electric battery via the charging device.

One embodiment of the charging device 4 according to the invention mainly comprises an electrical converter, for example an electrical voltage converter 6, to convert the electrical signal available at the output of the electrical energy source into an electrical signal suitable for charging the battery, a means 3 for activating and deactivating the charging of the battery, such as, for example, a controlled switch 3, and a logical processing unit 7 controlling the voltage converter and/or the means for activating and deactivating the charging of the battery.

The logical processing unit 7 is preferably connected via a link 8 to the electrical energy source and/or via a link 9 to the electrical charge. Thus, the logical processing unit can collect information relating to the operation of the electrical charge, notably information relating to its energy consumption, for example energy consumption prediction information and/or can collect information relating to the electrical energy source, notably information relating to its energy production, for example energy production prediction information. The logical processing unit may also comprise other means to collect any other information. It can notably be connected to a man-machine interface allowing a user of the system to define preferences, such as a battery preservation level and/or a required stand-alone use of the electrical charge under given operating conditions, notably conditions of energy consumption of the electrical charge and conditions of availability of electrical energy in the electrical source. The logical processing unit 7 is also preferably connected to the electric battery. Thus, the logical processing unit can collect information relating to the charging of the battery.

The charging device, in particular the logical processing unit 7, comprises any means for controlling the operation of the charging device according to the charging method which forms the subject-matter of the invention. For this purpose, the logical processing unit comprises memories and software modules. The software modules may comprise computer programs. The charging device may comprise a data recording medium readable by a computer on which a computer program is recorded comprising software means to carry out the steps of the charging method which forms the subject-matter of the invention, in particular to carry out the steps of the embodiment of the charging method according to the invention described below. The logical processing unit preferably comprises a calculating means to calculate a first level of charge reference, a memory to store this first level of charge reference and a comparison means to compare the current charge of the battery with the first level of charge reference.

The electrical charge may be of any type, such as, notably, a lighting system, a vehicle or a portable computer.

The electrical energy source may also be of any type, notably the commercial electrical grid or a photovoltaic panel or an alternator.

One embodiment of the charging method according to the invention is described below with reference to FIG. 2.

In a first step 100, information concerning the system is collected. This step is preferably carried out by the previously described logical processing unit. The following information or parameters are also preferably collected:
predictable energy consumption of the electrical charge during a first time range, for example during the next A hours or during the next B days,
predictable available energy in the electrical energy source during a next second time range, for example during the next C hours or during the next D days, (A can be equal to C and/or B can be equal to D),
level of stand-alone use of the electrical charge required by the user under given operating conditions, notably conditions of energy consumption of the electrical charge and conditions of availability of electrical energy in the electrical source (this parameter may, for example, be expressed in hours of use of the electrical charge in a given operation in the absence of energy supplied by the electrical energy source);
level of charge of the battery below which it is not desirable to fall.

In a second step 110, a first level of charge reference value is defined. This first charge reference value is strictly less than the battery charge capacity. This step is preferably carried out by the logical processing unit, notably by calculating and modelling means contained in the logical processing unit. These means may comprise computer programs. To do this, previously collected parameters are used.

In a third step 120, a test is carried out to determine whether the electrical energy source produces or contains enough electrical energy to charge the battery. If not, the method loops to step 100 or step 120. Conversely, if so, the method moves on to a fourth step 130.

In the fourth step 130, the battery is charged thanks to the electrical energy source via the charging device, notably via the electrical converter. To do this, the operating parameters of the electrical converter are preferably defined and said converter is preferably put into operation with these parameters. In this step, the charging is activated thanks to the means 3, this means preferably being controlled by the logical processing unit. In one preferred embodiment, the controlled switch 3 is closed.

In a fourth step 140, a test is carried out to determine whether the first level of charge reference value is reached. If not, the method loops to step 100 or step 120. Conversely, if so, the method moves on to a sixth step 150. This test is preferably carried out in the logical processing unit.

In the sixth step 150, the battery charging is stopped. To do this, the charging is preferably deactivated thanks to the means 3. In the preferred embodiment, the controlled switch 3 is opened. The method then loops to step 100.

This charging method may be the subject-matter of miscellaneous variants. Notably, in the previously described variant, the first level of charge reference changes through time as a function of the different current parameters collected. It is, for example, recalculated at any time. Alternatively, the first reference value can be calculated once and for all during the design or during the manufacture of the system. As a further alternative, the first reference value can be calculated during a system configuration phase. In these last two cases, the first reference value is then activated or deactivated according to the data or according to the operation of the system.

It is also possible to define, in addition to the first level of charge reference value, a second level of charge reference value. It is thus possible that, according to the energy consumption of the electrical charge and/or according to the energy production of the electrical source and/or according to the battery preservation level required by the user and/or according to the stand-alone use of the electrical charge required by the user, in the test of the sixth step 150, the first level of charge reference value is replaced by the second level of charge reference value. Obviously, steps similar to steps 100 and 110 are then necessary to define the second level of charge reference value. Alternatively, the second charge reference value may be equal to the maximum charge capacity of the electric battery.

Different embodiments of electrical systems according to the invention are described in detail below.

A first example relates to a lighting system, for example a public urban lighting system.

The light production system is made up of electroluminescent diodes consuming 30 W in operation. The system is first dimensioned under winter conditions. On the basis of an operating period of 12 hours per day and an energy efficiency of the system of 80%, the system consumes 450 Wh per day. To calculate the power of the photovoltaic panel to be installed, an irradiation of 1.5 kWh/m²/day is assumed, which allows the power of the photovoltaic panel to be determined as equal to 300 We (or approximately 3 m2 of panel). The dimensioning of the battery is based on the fact that a stand-alone period of 5 days of operation is required, corresponding to a critical case of 5 consecutive days without solar radiation. A battery with a capacity of 2.25 kWh (5 d×450 Wh), or approximately 188 Ah at 12 V) is therefore installed. The system has thus been dimensioned in a conventional manner to operate in the worst-case scenario (winter).

However, in summer, the system has an excess of energy since the solar irradiation changes from 1.5 to 10 kWh/m²/day. Furthermore, since the night-time period has reduced, the energy storage capacity of the battery becomes overdimensioned in relation to the energy consumed. This causes an increase in the state of charge (level of charge) of the battery since discharges are smaller and charges are greater. For an 8-hour night-time period, the necessary storage energy changes to 1.5 kWh (30 W/80%×8 h×5 d).

In accordance with the method according to the invention, in order to preserve the battery, a logical processing unit recalculates the state of charge (level of charge) which is enough to prevent the battery from being continuously at a level of high charge when this is not necessary. The level of charge must only be enough to provide the required stand-alone operation. In this case, where the 5-day summer consumption is 1.5 kWh, the logical processing unit stops the charging of the battery when the stored energy is greater than or equal to a charge reference value of 1.5 kWh (or approximately 70% of the battery charge capacity). As shown in FIG. 3, this reduces the average level of charge of the battery and therefore preserves the battery from the aforementioned damage phenomena. Similarly, a 10% discharge depth margin is allowed to prevent deep discharges of the battery from being carried out when the battery is charged at a very low level. The end-of-discharge reference value is thus determined in such a way as to prevent the level of charge of the battery from falling below a level corresponding to 10% of the maximum capacity of the battery charge.

A second example relates to a sailing boat.

The table below presents in a general manner the daily energy consumption of a sailing vessel equipped to make a transatlantic crossing. The batteries are recharged by an alternator operating approximately 2 hours per day and powering the main safety components of the boat during this time.

| | Consumption | Proportion of the |
|---|---|---|
| Consumers | (Wh) | consumption |
| Miscellaneous lighting | 30 | 2.47% |
| Navigation lights | 20 | 1.65% |
| PC | 84 | 6.91% |
| Ampere meter/voltmeter | 0.2 | 0.02% |
| Controls | 900 | 74.03% |
| GPS | 2.88 | 0.24% |
| VHF | 115.2 | 9.48% |
| Repeaters | 34.56 | 2.84% |
| Wind vane air-speed | 17.28 | 1.42% |
| indicator | | |
| Echo sounder | 11.52 | 0.95% |
| Total | 1216 | |

The storage batteries must therefore be dimensioned to enable a stand-alone period of 22 hours before the alternator is started up on the following day. Since the daily consumption is approximately 1220 Wh and on the basis of an average efficiency of the installation of 80%, the batteries must be capable of supplying 1525 Wh, i.e. approximately 128 Ah at 12 V. The system has therefore been dimensioned in a conventional manner to operate in the worst-case scenario of a 24-hour race.

However, in a different operating mode, or even when the boat remains in dock, the energy consumption is much less given that in any event the consumption linked to the ease of use of the helm control will be reduced considerably or even eliminated. In order to preserve the battery, the processing unit recalculates the state of charge, i.e. the level of charge of the battery necessary for providing the required stand-alone operation. Consequently, the charging of the batteries is limited to this value. This prevents the battery from operating needlessly at a high state of charge. In this case, where the consumption linked to the helm control is eliminated (i.e. 900 Wh), it is no longer necessary to store the 1125 Wh (900/0.8) provided for this component. The value of the energy to be stored therefore changes from 1525 Wh to 400 Wh. The logical processing unit can therefore stop the charging of the battery when the energy stored in the battery is greater than or equal to 400 Wh (i.e. approximately 26% SOC, 26% of the maximum storage capacity of the date). This allows the average level of charge to be reduced and therefore the battery to be preserved from the aforementioned damage phenomena. In the same way as seen above, a 10% discharge depth margin is allowed to prevent the battery from being discharged when its level of charge is low. By charging the battery to only around 36% of its maximum charge capacity (around 550 Wh), the battery is therefore preserved in a lasting manner while providing continuous service.

A third example relates to a portable computer. Once charged, the battery of a portable computer normally provides stand-alone operation for 5 hours. Some users only very occasionally need such a stand-alone period, but very often require a reduced stand-alone period of 2 hours.

The charging method according to the invention can be applied to such a case. In fact, with the method according to the invention, it is possible to reduce the normal level of charge of the battery to a level sufficient to provide a stand-alone period of 2 hours of use of the computer. Conversely, when the user anticipates an exceptional need for greater stand-alone period, for example a stand-alone period of 5 hours, he can, according to the invention, indicate this to the charging device which will then authorise the full charging of the battery.

Throughout this document, the term “level of charge” is understood to mean the electrical energy stored in the battery which can be recovered by the latter. This notion is also referred to as the “state of charge” or “SOC”, and is expressed as a percentage of the maximum charge capacity of the battery or “% SOC”.

1. A method for charging an electric battery with a given charge capacity, the electric battery feeding a charge and the electric battery being charged by an electrical energy source, comprising:
defining a first level of charge reference value lower than the charge capacity of the battery; and
charging the electric battery until the first level of charge reference value is reached.

2. The method according to claim 1, wherein the first level of charge reference value depends on a first set of parameters.

3. The method according to claim 2, wherein the first set of parameters comprises a parameter to predict the energy deliverable by the battery to feed the charge in a first given time range or a parameter to predict the energy receivable from the electrical energy source by the battery in a second given time range or a level of stand-alone use of the electrical charge or a level of charge of the battery below which the battery is not to fall.

4. The method according to claim 1, comprising:
defining a second level of charge reference value; and
charging the electric battery until the first or the second level of charge reference value is reached.

5. The method according to claim 4, wherein the second level of charge reference value depends on a second set of parameters.

6. The method according to claim 5, wherein the second set of parameters comprises a parameter to predict the energy which will have to be delivered by the battery to feed the charge in a third given time range or a parameter to predict the energy receivable from the electrical energy source by the battery in a fourth given time range or a level of preservation of the battery or a level of stand-alone use of the electrical charge or a level of charge of the battery below which the battery is not to fall.

7. The method according to claim 4, wherein the second level of charge reference value is equal to the charge capacity of the battery.

8. A non-transitory computer-readable storage medium having stored thereon a computer program to cause a processor to perform the steps of the method according to claim 1.

9. A device for charging an electric battery, comprising hardware to carry out the charging method according to claim 1.

10. The device according to claim 9, wherein the hardware comprises a logical processing unit or a means for activating and deactivating the charging of the battery.

11. A power supply system comprising:
a charging device according to claim 9: and
an electric battery.

12. The supply system according to claim 11, comprising an electrical energy source, wherein the electrical energy source is a photovoltaic panel.

13. A system comprising:
a power supply system according to claim 11; and
an electrical charge.

14. A non-transitory computer-readable storage medium having stored thereon a computer program to cause a processor to perform the steps of the method according to claim 1, when the program runs on a computer.
